(19) United States
(12) Patent Application Publication
(10) Pub. No.: US 2023/0206058 A1
(43) Pub. Date: Jun. 29, 2023

(54) PROCESSING SEQUENCES OF MULTI-MODAL ENTITY FEATURES USING CONVOLUTIONAL NEURAL NETWORKS

(71) Applicant: Fidelity Information Services, LLC, Jacksonville, FL (US)

(72) Inventors: Benjamin Wellmann, Jacksonville, FL (US); Gary Duma, Jacksonville, FL (US)

(21) Appl. No.: 17/564,373

(22) Filed: Dec. 29, 2021

(51) Int. Cl. G06N 3/08

(52) U.S. Cl. CPC G06N 3/08

(57) ABSTRACT

Methods, systems, and apparatus, including computer programs encoded on computer storage media, for processing sequences of multi-modal entity data using convolutional neural networks. One of the methods includes receiving an input sequence of multi-modal feature vectors characterizing an entity over a time window, wherein each multi-modal feature vector in the input sequence corresponds to a different time interval during the time window; processing the input sequence of multi-modal feature vectors using a convolutional neural network to generate a latent sequence that comprises a plurality of latent feature vectors; processing the latent sequence of latent feature vectors using an aggregation neural network to generate an aggregated feature vector; and processing the aggregated feature vector using an output neural network to generate a prediction that characterizes the entity after the time window.

### BACKGROUND

This specification relates to processing time series data using neural networks and, more specifically, convolutional neural networks to generate predicted outputs characterizing entities.

A neural network is a machine learning model that includes an output layer and one or more hidden layers, at least some of which apply a non-linear transformation to a received input to generate an output.

### SUMMARY

This specification describes a system implemented as computer programs on one or more computers in one or more locations that generates a prediction about the future behavior of an entity by processing a sequence of multi-modal feature vectors characterizing the entity using a neural network.

Each feature vector in the sequence corresponds to a different time interval during a time window and characterizes the entity during the corresponding time interval. The feature vectors are referred to as “multi-modal” because each feature vector is generated from multiple different types of features that characterize the entity during the corresponding time interval.

The neural network includes a convolutional neural network, i.e., a neural network that includes one or more convolutional layers with a one-dimensional kernel, that processes the sequence of feature vectors to generate as output a latent sequence of latent feature vectors.

The neural network also includes an aggregation neural network, e.g., a recurrent neural network, that receives as input the output of the convolutional neural network, i.e., the latent sequence, and processes the output of the aggregation neural network to generate an aggregated feature vector.

The neural network also includes an output neural network that processes the aggregated feature vector to generate the prediction about the entity.

In some aspects, a method includes receiving an input sequence of multi-modal feature vectors characterizing an entity over a time window, wherein each multi-modal feature vector in the input sequence corresponds to a different time interval during the time window; processing the input sequence of multi-modal feature vectors using a convolutional neural network to generate a latent sequence that comprises a plurality of latent feature vectors; processing the latent sequence of latent feature vectors using an aggregation neural network to generate an aggregated feature vector; and processing the aggregated feature vector using an output neural network to generate a prediction that characterizes the entity after the time window.

Some aspects of the described subject matter include one, some, or all of the below features.

The convolutional neural network comprises a plurality of convolutional layers that each have a respective one-dimensional kernel.

The aggregation neural network is a recurrent neural network.

The output neural network comprises one or more fully-connected layers followed by an output layer.

The method further includes obtaining data characterizing the entity from a plurality of different data streams that each correspond to a respective non-standardized format; and generating the multi-modal feature vectors in the input sequence by converting the data characterizing the entity into a standardized format.

Generating each multi-modal feature vector can include identifying respective features of each of a plurality of feature types that characterize the entity during the corresponding time interval for the multi-modal feature vector and for each feature type, adding the identified respective features of the feature type to one or more entries of the multi-modal feature vector that correspond to the feature type.

The convolutional neural network, the aggregation neural network, and the output neural network have been jointly trained on training data that includes a plurality of training input sequences and, for each training input sequence, a corresponding ground truth outcome.

The entity is a financial asset, and each multi-modal feature vector comprises technical analysis features and sentiment analysis features.

Each multi-modal feature vector further comprises fundamental analysis features.

Particular embodiments of the subject matter described in this specification can be implemented so as to realize one or more of the following advantages.

By making predictions using the described deep neural network, a system can accurately account for complex temporal dependencies between different modalities of features to make an accurate prediction about the future behavior of an entity. In particular, the deep neural network can use one-dimensional convolutions to combine different modalities of features across time. The deep neural network can then use an aggregation neural network, e.g., an RNN, to aggregate these features into a single vector that represents the features from the multiple modalities that are relevant to the future behavior of the entity and then make the prediction from the aggregated feature. This neural network architecture results in a deep neural network that can make accurate predictions. Moreover, this neural network architecture is adapted to being fine-tuned in order to make predictions about different entities, different time horizons, or from specialized data. That is, once a neural network having the described architecture is pre-trained, the neural network can be fine-tuned in a data-efficient and computationally-efficient manner to perform any of a variety of prediction tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example prediction system.

FIG. 1B shows an example user interface.

FIG. 2 shows an example data intake system.

FIG. 3 is a flow diagram of an example process for generating a prediction characterizing an entity.

FIG. 4 is a flow diagram of an example process for training the prediction neural network.

Like reference numbers and designations in the various drawings indicate like elements.

### DETAILED DESCRIPTION

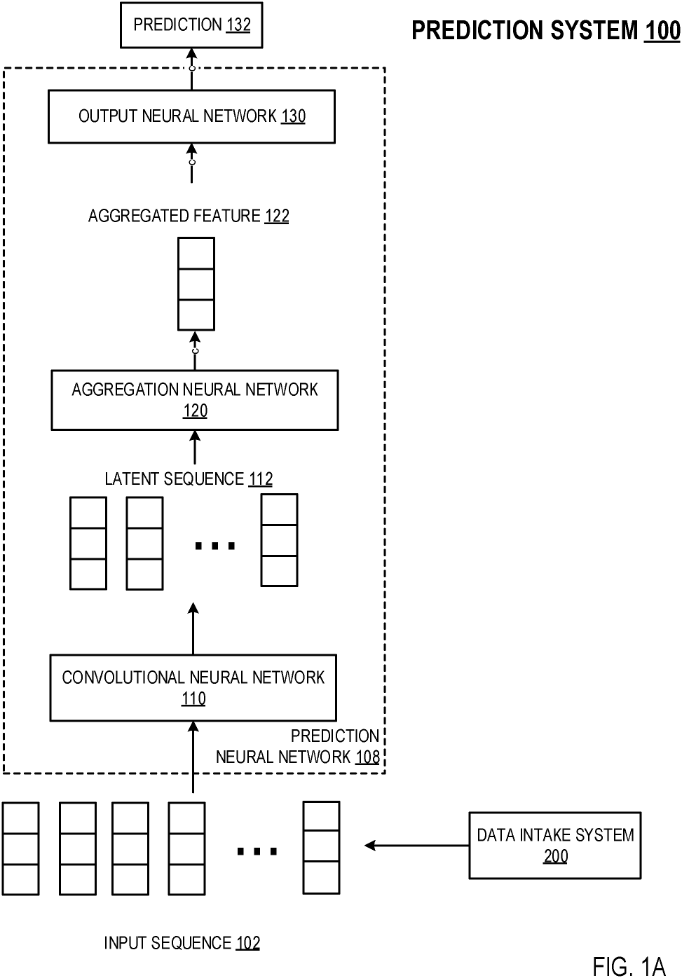

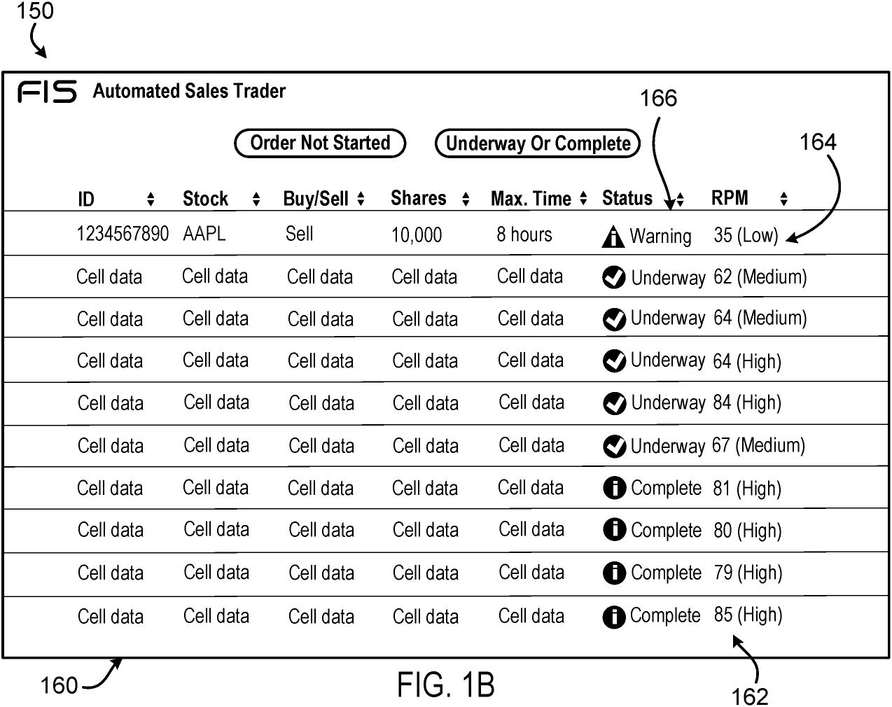

FIG. 1A shows an example prediction system 100. The prediction system 100 is an example of a system implemented as computer programs on one or more computers in one or more locations, in which the systems, components, and techniques described below can be implemented.

The system 100 processes an input sequence 102 that includes feature vectors characterizing an entity using a prediction neural network 108 to generate a prediction 132 about the future behavior of the entity.

In general, the input sequence 102 corresponds to a fixed size time window and the prediction 132 is a prediction about the future behavior of the entity after the time window elapses.

More specifically, each feature vector in the input sequence 102 corresponds to a respective time interval during the time window and includes data characterizing the entity during the corresponding time interval.

Generally, each feature vector in the input sequence 102 includes features representing multiple modalities of information about the entity. That is, each feature vector is a multi-modal feature vector that is generated from multiple different types of features that each characterize a different aspect of the entity during the corresponding time interval.

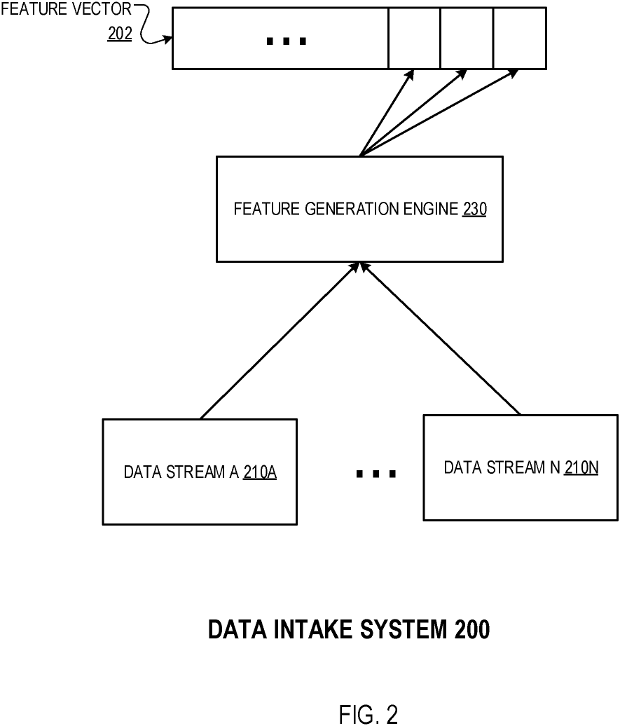

A data intake system 200 collects data about entities and generates, from the collected data, input sequences 102 for processing by the prediction neural network 108. Generally, the data intake system 200 repeatedly combines multiple different types of features into a single feature vector in order to generate the input sequence 102. The operation of the data intake system 200 is described in more detail below with reference to FIG. 2.

As a particular example, the entity can be a financial asset, e.g., a stock, a commodity, a cryptocurrency, or a different type of financial asset.

The feature vectors in the input sequence 102 can characterize the financial asset over a time window and the prediction 132 can be a prediction that characterizes the predicted future trading behavior of the financial asset after the end of the time window. As a particular example, the prediction 132 can characterize the predicted trading behavior of the financial asset at the end of the next time interval after the end of the time window.

When the entity is a financial asset, each feature vector can be generated from multiple different types of features that each characterize the asset in a different way. As a particular example, the features can include technical analysis features, sentiment analysis features and, optionally, fundamental analysis features. Generating feature vectors when the entity is a financial asset is described in more detail below with reference to FIG. 2.

In some cases, the time window can be a relatively longer time window. For example, the time window can cover thirty or sixty days or ninety days and the time intervals can each be one day long. Thus, in this example, when the time window is sixty days, the input sequence 102 can include sixty feature vectors, with each feature vector corresponding to a different one of the sixty days and including information characterizing the financial asset during the corresponding day. Moreover, the prediction 132 can characterize the price of the asset one day after the end of the sixty day time window.

In some other cases, the time window can be a relatively shorter time window. For example, the time window can cover several seconds or minutes and the time intervals can each be a predetermined fraction of the time window.

The prediction 132 can include any of a variety of predictions about the future trading behavior of the financial asset.

For example, the prediction can characterize the future price of the financial asset. As one example, the prediction 132 can include a probability distribution that assigns a respective probability to each of a plurality of outcomes. For example, each outcome can correspond to a different range of percentage changes in the price of the asset, e.g., the percent change in the price of the asset from the end of the time window (the “current price”) to the end of the next time interval after the end of the time window. For example, one outcome can correspond to the price staying within 5% of the current price, another outcome can correspond to the price increasing more than 5% of the current price, and a third outcome can correspond to the price decreasing more than 5% of the current price.

As another example, the prediction 132 can include a regressed value that represents the predicted change, i.e., the percent change or the absolute change, in the price of the asset from the end of the time window to the end of the next time interval after the end of the time window.

As another example, the prediction 132 can also include, i.e., in addition to the probability distribution, the regressed value, or both, a measure of uncertainty. In some cases, the neural network 108 generates the measure of uncertainty independently, i.e., using a different set of one or more output layers from the set that generates the remainder of the prediction. In some other cases, the system 100 generates the measure of uncertainty based on the predictions of the neural network 108 for one or more most recent time windows that immediately precede the current time window, e.g., by computing a variance or other measure of divergence between the most recent predictions.

As another example, the prediction 132 can characterize the trading volume of the financial asset during the next time interval after the end of the time window.

In some cases, the system 100 maintains multiple instances of the neural network 108, with different instances of the neural network 108 having been trained to generate different respective predictions 132 that characterize the future training behavior of the financial asset differently.

For example, different instances of the neural network 108 can be configured to generate predictions over different time horizons after the end of the current time window, e.g., with one instance making predictions about the trading behavior of the asset after a relatively short time interval after the end of the current time window and another instance making predictions about the trading behavior of the asset after a relatively longer time interval after the end of the current time window.

As another example, different instances of the neural network 108 can correspond to different venues through which the financial asset can be traded, e.g., different regulated markets (e.g., stock exchange), multilateral trading facilities (MTF) and organised trading facilities (OTF) where the financial asset can be traded. Thus, each instance can make predictions about the future trading behavior if traded at the corresponding trading venue.

As yet another example, for each trading venue, the system 100 can maintain multiple different instances that correspond to the trading venue but that make predictions over different time horizons.

In some cases, as will be described below, each instance can be generated by fine-tuning the same pre-trained neural network 108 on a different set of training data.

The prediction neural network 108 includes a convolutional neural network 110, an aggregation neural network 120, and an output neural network 130.

The system 100 processes the input sequence 102 using the convolutional neural network 110 to generate a latent sequence 112 that includes a plurality of latent vectors. Each latent vector generally corresponds to a respective latent time interval within the time window.

In some implementations, the latent time intervals are the same length as the input time intervals and each latent feature vector has a corresponding input vector in the input sequence 102.

In some other implementations, the latent time intervals are longer than the input time intervals. In these implementations, the latent sequence 102 includes fewer vectors than the input sequence 102 and each latent feature vector corresponds to multiple ones of the input feature vectors.

Additionally, depending on the configuration of the convolutional neural network 110, the dimensionality of the latent feature vectors can be the same as or larger than the dimensionality of the input feature vectors.

Generally, the convolutional neural network 110 is a neural network that includes one or more convolutional neural network layers with one-dimensional kernels.

The convolutional neural network 110 can also include other types of neural network layers, e.g., batch normalization layers, layer normalization layers, pooling layers, dropout layers, and so on.

As a particular example, the neural network 110 can include a stack of convolutional layers with one-dimensional kernels, with each convolutional layer other than the last convolutional layer in the stack being followed by a respective normalization layer, e.g., batch normalization, layer normalization, and so on, and, during training, a dropout layer.

By using the convolutional neural network 110, the system 100 can generate latent vectors that incorporate temporal context from neighboring time intervals. By increasing the width of the kernels of the convolutional layers, increasing the number of convolutional layers, or both, the system can expand how much temporal context each given convolutional layer incorporates.

The system 100 then processes the latent sequence 112 using the aggregation neural network 120. The aggregation neural network 120 processes the latent vectors in the latent sequence 112 to generate an aggregated feature vector 122 that characterizes the entity over the entire time window.

For example, the aggregation neural network 120 can be a recurrent neural network, e.g., a long-short term memory (LSTM) neural network or a gated recurrent unit (GRU) neural network, that initializes a hidden state prior to processing the first latent feature vector in the latent sequence and then updates the hidden state when processing each latent feature vector in the latent sequence 112. In this example, the aggregated feature vector 122 can be the hidden state of the last recurrent layer in the recurrent neural network after processing the last feature vector in the latent sequence 112.

The system 100 processes the aggregated feature vector 122 using the output neural network 130 to generate the prediction 132 for the entity.

For example, the output neural network 130 can include one or more fully-connected neural network layers followed by an output layer that is appropriate for the type of prediction 132 being generated by the system 100.

For example, when the prediction 132 is a probability distribution over multiple possible classes, the output layer can be a softmax layer.

As another example, when the prediction 132 includes one or more regressed values, the output layer can be a linear layer with a number of nodes that is equal to the number of values that need to be regressed.

While the description of FIG. 1A shows the processing of the prediction neural network 108 for a single input sequence 102, i.e., to generate a single prediction 132 for a single entity based on features for that entity during a single time window, in practice the system 100 can be configured to make many different predictions with low latency.

In particular, the system 100 can be configured to generate a new prediction 132 for the entity each time a new time interval elapses. That is, each time a new time interval elapses, the system 100 discards the feature vector for the oldest time interval in the time window and adds, to the end of the input sequence, a new feature vector for the new time interval to generate a new input sequence. The system 100 then processes the new input sequence using the prediction neural network 108 to generate a new prediction.

As another example, the system 100 can be configured to generate predictions 132 for many different entities in parallel. That is, each time a new time interval elapses, the system 100 can generate a respective input sequence for each entity in a set of multiple entities and then process each input sequence using the prediction neural network 108 to generate a respective prediction 132 for each entity in the set.

To reduce the latency of these predictions, the system 100 can be co-located with the downstream system that makes use of the predictions 132 generated by the system.

As another example, the system 100 can deploy a respective instance of the neural network 108 for each entity of interest and maintain a separate data stream for each entity to ensure that predictions for each entity can be made quickly.

As yet another example, each instance of the neural network 108 can be deployed on a respective hardware accelerator, e.g., a graphics processing unit (GPU) or a special-purpose ASIC designed for accelerating neural network computations.

Once the system has generated the prediction 132, the system 100 or another system can use the prediction 132 for any of a variety of purposes.

As one example, when the entity is a financial asset, the system 100 can apply one or more rules to the prediction 132 to determine whether to initiate an automatic trade of the financial asset. For example, the system can determine that, if the probability assigned to a specific percentage range exceeds a threshold, an automated buy or sell of the asset should be initiated.

As another example, the system 100 can generate a respective prediction 132 for each asset in a portfolio of assets that has been identified by a user. The system 100 can then use the respective predictions 132 to identify which assets in the portfolio should be recommended to the user for further analysis.

For example, the system 100 can determine to recommend any asset that is predicted with sufficient likelihood to have a price change of at least a threshold percentage. The recommended assets can then be identified in a user interface that is presented to the user on a user computer. Optionally, data derived from the input sequences for the identified asset can also presented to the user, e.g., technical analysis data for the asset, sentiment analysis data for the asset, and so on. For example, the user interface can include a “dashboard” that presents a summary of the features for each identified asset recommendation and allows the user to navigate between recommended assets.

FIG. 1B shows an example user interface 150 that presents data generated as a result of predictions made by the neural network 108.

In particular, in FIG. 1B, the assets of interest are those that are the subject of trades that are either underway or have been completed.

The user interface 150 includes a portion 160 that identifies the trades that are underway or have been completed.

For each trade identified in the first portion 160, the first portion 160 includes an “RPM” column 162 that displays a score (a “Relative Performance Measure”) that has been generated using predictions made by the neural network 108 and that characterizes the degree to which the trade aligns with the predictions of the neural network 108 for the corresponding asset, i.e., with higher scores indicating that the trade more strongly aligns with the prediction of the neural network 108.

As can be seen from the example of FIG. 1B, the trade 164 to sell 10,000 shares of AAPL within 8 hours has a relatively low RPM of 35, indicating that the prediction generated by the neural network 108 for this asset indicates that the asset will likely increase in price after the conclusion of the 8 hour window, thereby making the decision to sell shares of the asset a poor decision. As a result, the user interface 150 displays a warning 166 that indicates that the RPM is low for the trade 164, e.g., giving a user an opportunity to further analyze the trade or to cancel the trade before it is completed.

While the user interface 150 is one example of a way in which the predictions made by the neural network 108 can be used, other examples are also possible.

As another example, the system can use neural network 108 to determining a routing for an order. For example, as described above, the system can maintain multiple instances of the neural network 108 that correspond to different time horizons, different venues or both. When the system 100 receives data specifying an order for a particular asset, the system 100 can determine a time by which the order must be completed and the trading venues through which the order can be completed. The system can then determine, based on the predictions made by the instances of the neural network 108 for each trading venue (and optionally for each of multiple time horizons), a routing for the order that specifies when to place the order, which venue to place the order in, or both, and then provide information indicating the routing to a user or automatically execute the order according to the routing.

As another example, the system 100 can generate predictions 132 as part of testing or evaluating an investment strategy or a portfolio allocation. That is, the system 100 or another system can use the predictions 132 for multiple different assets to automatically adjust an investment strategy or portfolio allocation, i.e., by computing an overall predicted return for multiple different investment strategies and selecting, as the final strategy, the strategy having the best overall predicted return.

Prior to using the neural network 108 to generate predictions, the system 100 or another training system trains the neural network 108 on training data.

The training data includes a set of training input sequences that each correspond to a respective entity and, for each training input sequence, a ground truth outcome that characterizes what actually happened to the corresponding entity after the time window covered by the training input sequence ended.

The system can then train the neural network 108 on the training data using any appropriate supervised learning technique. For example, the system can train the neural network 108 using an appropriate optimizer, e.g., Adam, rmsProp, or Adafactor, to minimize an appropriate loss function, e.g., a classification loss, a regression loss, or a loss that includes both classification and regression loss terms, that measures errors between predictions for training input sequences and the corresponding ground truth outcomes for the training input sequences.

In some cases, a training system can first train the neural network 108 on training data that includes training input sequences corresponding to a large number of entities and then, prior to deploying the neural network 108 for making predictions for a particular user of the system 100, the system can fine-tune the neural network on training input sequences that are specific to the particular user. For example, the particular user can be interested in some small subset of the larger set of entities or a set of entities that includes entities that were not represented in the training data used to train the neural network 108.

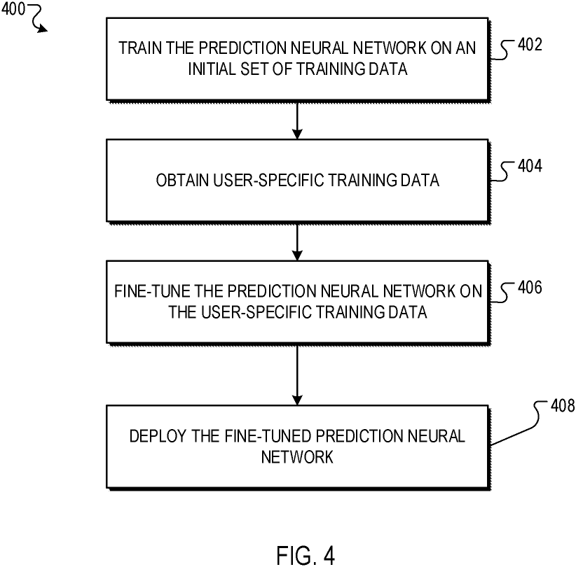

Fine-tuning the neural network is described in more detail below with reference to FIG. 4.

FIG. 2 shows an example data intake system 200.

The data intake system 200 is an example of a system that processes data characterizing entities to generate input sequences 102 for processing by the prediction neural network 108.

In particular, the data intake system 200 receives data from multiple different data streams 210A-210N of a variety of different types and in a variety of different formats and combines the data to generate data that is in a standardized format that can be processed by the neural network 108.

In particular, each feature vector 202 is required to be in a standardized format in order to be processed by the neural network 108. More specifically, each feature vector 202 includes the same number of entries, i.e., the same number of numeric values, and each entry in a given feature vector 202 must correspond to the same type of feature as the corresponding entry in the other feature vectors in the input sequence.

Thus, during operation of the prediction system 100, a feature generation engine 230 within the system 200 repeatedly converts data received about a given entity from the data streams 210A-210N into a standardized format by collecting the data that corresponds to each time interval into a single feature vector in a consistent order.

In particular, the neural network 108 is configured to receive features in which each numeric value falls within a certain standardized range, e.g., between zero and one or from zero to two-hundred fifty five.

However, each data stream 210A-210N can provide data with values that do not fall within this range and different data streams can provide data from different ranges. Thus, the system standardizes each value received from each of the data streams to generate features that are in the standardized format that is required for processing by the neural network 108. In particular, the system can generate a feature vector for a given time interval by, for each value received from a given data stream that corresponds to the given time interval, re-scaling the value so that it falls within the standardized range and inserting it into an entry of the feature vector that corresponds to the data stream. The system can re-scale a value from a given data stream using re-scaling data that is specific to the data stream, i.e., that specifies a mapping from raw values to values in the standardized range that is based on the minimums and maximums of historical values received from the data stream.

The data streams 210A-210N can be, e.g., automatic programming interfaces (APIs), or other interfaces that allow the system 200 to repeatedly obtain data for each entity in a set of entities, e.g., each of multiple financial assets.

In some cases, each data stream 210A-210N corresponds to a different type of feature. In some other cases, different data streams 210A-210N can correspond to the same feature type.

As described above, when the entity is a financial asset, each feature vector includes technical analysis features, sentiment analysis features, and, optionally, fundamental analysis features. Thus, in these cases, at least one of the data streams 210A-210N provides technical analysis data, at least one of the data streams 210A-210N provides sentiment data, and, when fundamental analysis features are included, at least one of the data streams 210A-210N provides fundamental analysis data.

The technical analysis data for a given time interval characterizes the price and, optionally, trading volume of the financial asset during the time interval and, optionally, at previous time intervals. For example, the system can obtain, from one or more of the data streams 210A-210N, features such as moving averages of the price of the financial asset, the momentum of the price of the financial asset, the crossover of the financial asset, probability bands for the financial asset and so on. Each of these features can be computed at various granularities, i.e., across various time scales. The engine 230 can then generate the corresponding entries in the corresponding feature vectors by including the technical analysis features at the different granularities in the corresponding entries of the feature vector.

The sentiment data can characterize the sentiment of news articles, social media posts, and other communications about the entity during a given time period.

In some implementations, the system 200 obtains, from one or more of the data streams 210A-210N, sentiment measures that have already been computed for communications generated during a given time window. The engine 230 can then generate the corresponding entries in the corresponding feature vector by computing various statistics over the received sentiment measures, e.g., the mean, median, mode and so on of the sentiment measures, and including the statistics in the feature vector. In some implementations, the engine 230 separately computes statistics for different types of communications, e.g., separate statistics for news articles and social media posts.

In some other implementations, the system 200 obtains the text of the communications from the data streams 210A-210N and then applies sentiment analysis techniques, e.g., machine learning-based sentiment analysis, over each communication to generate a respective sentiment score for each communication. The engine 230 can then generate the corresponding entries in the corresponding feature vector by computing various statistics over the generated sentiment measures, e.g., the mean, median, mode and so on of the sentiment measures, and including the statistics in the feature vector. In some implementations, the engine 230 separately computes statistics for different types of communications, e.g., separate statistics for news articles and social media posts.

The fundamental analysis data includes data that characterizes the intrinsic value of the asset. For example, the system 200 can obtain, from one or more of the data streams 210A-210N, features that have been extracted from financial statements for the asset. Examples of such features include earnings, expenses, assets, and liabilities. In some other implementations, the system 200 obtains the financial statements and then uses natural language processing techniques to extract the fundamental analysis features from the financial statements.

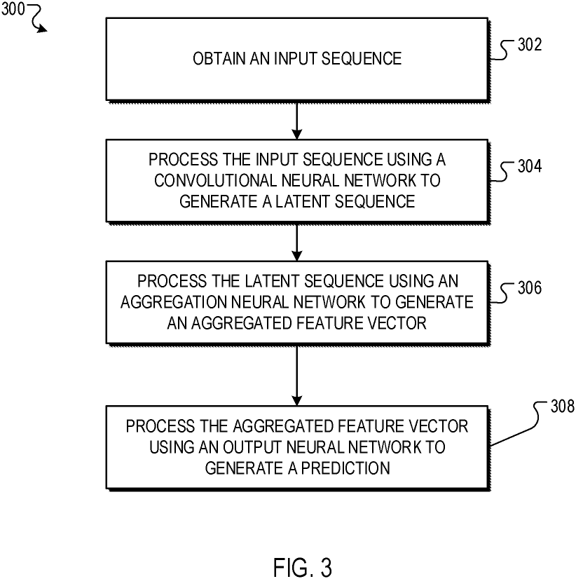

FIG. 3 is a flow diagram of an example process 300 for generating a prediction for an input sequence. For convenience, the process 300 will be described as being performed by a system of one or more computers located in one or more locations. For example, a prediction system, e.g., the prediction system 100 of FIG. 1A, appropriately programmed, can perform the process 300.

The system can perform an iteration of the process 300 each time a new time interval ends, i.e., once features for a new time interval become available.

The system receives an input sequence of multi-modal feature vectors characterizing an entity over a time window (step 302). Each multi-modal feature vector in the input sequence corresponds to a different time interval during the time window. That is, each feature vector corresponds to a different proper subset of the time window.

The system processes the input sequence of multi-modal feature vectors using a convolutional neural network to generate a latent sequence that includes a plurality of latent feature vectors (step 304). The convolutional neural network includes one or more one-dimensional convolutional layers, i.e., convolutional layers with 1-dimensional kernels. In some implementations, the latent sequence has a reduced frequency but includes a larger number of features relative to the input sequence.

The system processes the latent sequence of latent feature vectors using an aggregation neural network to generate an aggregated feature vector (step 306). For example, the aggregation neural network can be a recurrent neural network that updates a hidden state as part of processing each latent feature vector in the latent sequence. As a particular example, the aggregated feature vector can be the hidden state of the last recurrent layer in the aggregation neural network after processing the last latent feature vector in the latent sequence.

The system processes the aggregated feature vector using an output neural network to generate a prediction that characterizes the entity after the time window (step 308). For example, the output neural network can include one or more fully-connected layers followed by an output layer.

FIG. 4 is a flow diagram of an example process 400 for training the prediction neural network. For convenience, the process 400 will be described as being performed by a system of one or more computers located in one or more locations. For example, a prediction system, e.g., the prediction system 100 of FIG. 1A, appropriately programmed, can perform the process 400.

The system trains the prediction neural network on an initial set of training data (step 402).

The training data includes a set of training input sequences that each correspond to a respective entity and, for each training input sequence, a ground truth outcome that characterizes what actually happened to the corresponding entity after the time window covered by the training input sequence.

The system can train the neural network on the training data using any appropriate supervised learning technique. For example, the system can train the neural network using an appropriate optimizer, e.g., Adam, rmsProp, or Adafactor, to minimize an appropriate loss function, e.g., a classification loss, a regression loss, or a loss that includes both classification and regression loss terms, that measures errors between predictions for training input sequences and the corresponding ground truth outcomes for the training input sequences.

The system obtains user-specific training data for a particular user of the system (step 404).

For example, a user can identify a proper subset of the entities represented in the training data used to train the neural network in step 402 that the user is interested in, and the system can generate user-specific training data that includes only the entities in the proper subset.

As another example, the user can provide a set of training data that includes training input sequences for entities that are of interest to the user.

As yet another example, the user can provide historical data characterizing entities that the user is interested in and the system can generate the user-specific training data by generating a set of training input sequences from the historical data.

The system fine-tunes the prediction neural network by training the prediction neural network on the user-specific training data (step 406).

In particular, this process is referred to as “fine-tuning” because the system trains the prediction neural network starting from the values of the parameters of the prediction neural network that were determined through the training of step 402.

In some cases, the system trains the neural network on the user-specific training data on the same objective function and using the same supervised learning technique as was used for the training in step 402.

In some other cases, the system modifies the supervised learning technique for the fine-tuning in step 406. As one example, the system can train the neural network with a reduced learning rate when performing the fine-tuning step 406 than when performing the training in step 402. As another example, the system can hold the values of certain ones of the parameters of the prediction neural network fixed during the fine-tuning step 406. For example, the system can hold the parameters of the convolutional neural network fixed and adjust the parameters of the aggregation and output neural networks. As another example, the system can hold the parameters of the convolutional neural network and the aggregation neural network fixed and adjust the parameters of only the output neural network. Modifying the supervised learning technique can assist in preventing the prediction neural network from overfitting to the user-specific training data.

In some cases, the system can fine-tune multiple different instances of the neural network for the same user. For example, the user can provide or otherwise identify different training data sets, with each training data set corresponding to a respective time horizon, i.e., so that, for each instance, the ground truth outcomes occur at a different time horizon after the end of the corresponding training sequence. As another example, the user can provide or otherwise identify different training data sets, with each training data set including data only from a corresponding trading venue. Thus, each instance of the neural network is trained to make predictions that are specific to that trading venue.

During the fine-tuning of a given instance of the neural network, the system can implement any of a variety of techniques to improve the quality of the fine-tuned model. For example, during the fine-tuning, the system can periodically re-sample the training data based on the performance of the model, e.g., to favor inputs with certain features that the system has determined improve the performance of the neural network. That is, the system can periodically measure the performance during fine-tuning and use the performance measure to resample the training data for future training iterations during the fine-tuning.

After fine-tuning the prediction neural network, the system deploys the fine-tuned prediction neural network(s) for use by the user (step 408). That is, the system deploys the fine-tuned neural network by allowing the user to generate predictions for new input sequences using the fine-tuned prediction neural network.

In some cases, the system deploys the fine-tuned prediction neural network by instantiating one or more instances of the fine-tuned prediction neural network on one or more user computers controlled by the user. Optionally, in these cases, the initial training step 402 can be performed on a set of computers that are remote from and not accessible to the user, e.g., in a data center, while the fine-tuning step 406 can be performed on the one or more user computers. This ensures that the user does not have access to the larger set of training data that is used to perform the training step 402, e.g., in case the larger set of training data is proprietary or cannot be shared with the user for another reason.

In some other cases, the system deploys the fine-tuned prediction neural network for use by the user by allowing the user to provide, e.g., through an API, new input sequences and to obtain, e.g., through the API, corresponding predictions generated by the prediction neural network. In these cases, steps 402-408 can be performed in a data center that is remote from the user.

The system can perform steps 404-408 of the process 400 independently for multiple different users, each with a different set of user-specific training data, while only performing the initial training step 402 once. Because the set of training data 402 will generally be much larger than the user-specific training data sets, the system can generate a “custom” prediction neural network for multiple different users in a computationally efficient manner, i.e., because generating an additional “custom” prediction neural network for an additional user requires only performing a relatively computationally inexpensive fine-tuning step.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
one or more computers, and
one or more storage devices storing instructions that when executed by the one or more computers cause the one or more computers to perform operations comprising:
receiving an input sequence of multi-modal feature vectors characterizing an entity over a time window, wherein each multi-modal feature vector in the input sequence corresponds to a different time interval during the time window;
processing the input sequence of multi-modal feature vectors using a convolutional neural network to generate a latent sequence that comprises a plurality of latent feature vectors;
processing the latent sequence of latent feature vectors using an aggregation neural network to generate an aggregated feature vector; and
processing the aggregated feature vector using an output neural network to generate a prediction that characterizes the entity after the time window.

2. The system of claim 1, wherein the convolutional neural network comprises a plurality of convolutional layers that each have a respective one-dimensional kernel.

3. The system of claim 1, wherein the aggregation neural network is a recurrent neural network.

4. The system of claim 1, wherein the output neural network comprises one or more fully-connected layers followed by an output layer.

5. The system of claim 1, the operations further comprising:
obtaining data characterizing the entity from a plurality of different data streams; and
generating the multi-modal feature vectors in the input sequence by converting the data characterizing the entity into a standardized format.

6. The system of claim 5, wherein generating each multi-modal feature vector comprises:
identifying respective features of each of a plurality of feature types that characterize the entity during the corresponding time interval for the multi-modal feature vector; and
for each feature type, adding the identified respective features of the feature type to one or more entries of the multi-modal feature vector that correspond to the feature type.

7. The system of claim 1, wherein the convolutional neural network, the aggregation neural network, and the output neural network have been jointly trained on training data that includes a plurality of training input sequences and, for each training input sequence, a corresponding ground truth outcome.

8. The system of claim 1, wherein the entity is a financial asset, and wherein each multi-modal feature vector comprises technical analysis features and sentiment analysis features.

9. The system of claim 8, wherein each multi-modal feature vector further comprises fundamental analysis features.

10. The system of claim 8, wherein the prediction characterizes a predicted trading behavior of the financial asset at an end of a next time interval after the end of the time window.

11. A method performed by one or more computers, the method comprising:
receiving an input sequence of multi-modal feature vectors characterizing an entity over a time window, wherein each multi-modal feature vector in the input sequence corresponds to a different time interval during the time window;
processing the input sequence of multi-modal feature vectors using a convolutional neural network to generate a latent sequence that comprises a plurality of latent feature vectors;
processing the latent sequence of latent feature vectors using an aggregation neural network to generate an aggregated feature vector; and
processing the aggregated feature vector using an output neural network to generate a prediction that characterizes the entity after the time window.

12. The method of claim 11, wherein the convolutional neural network comprises a plurality of convolutional layers that each have a respective one-dimensional kernel.

13. The method of claim 11, wherein the aggregation neural network is a recurrent neural network.

14. The method of claim 11, wherein the output neural network comprises one or more fully-connected layers followed by an output layer.

15. The method of claim 11, further comprising:
obtaining data characterizing the entity from a plurality of different data streams; and
generating the multi-modal feature vectors in the input sequence by converting the data characterizing the entity into a standardized format.

16. The method of claim 15, wherein generating each multi-modal feature vector comprises:
identifying respective features of each of a plurality of feature types that characterize the entity during the corresponding time interval for the multi-modal feature vector; and
for each feature type, adding the identified respective features of the feature type to one or more entries of the multi-modal feature vector that correspond to the feature type.

17. The method of claim 11, wherein the convolutional neural network, the aggregation neural network, and the output neural network have been jointly trained on training data that includes a plurality of training input sequences and, for each training input sequence, a corresponding ground truth outcome.

18. The method of claim 11, wherein the entity is a financial asset, and wherein each multi-modal feature vector comprises technical analysis features and sentiment analysis features.

19. The method of claim 18, wherein each multi-modal feature vector further comprises fundamental analysis features.

20. One or more non-transitory computer-readable storage media storing instructions that when executed by one or more computers cause the one or more computers to perform operations comprising:
receiving an input sequence of multi-modal feature vectors characterizing an entity over a time window, wherein each multi-modal feature vector in the input sequence corresponds to a different time interval during the time window;
processing the input sequence of multi-modal feature vectors using a convolutional neural network to generate a latent sequence that comprises a plurality of latent feature vectors;
processing the latent sequence of latent feature vectors using an aggregation neural network to generate an aggregated feature vector; and
processing the aggregated feature vector using an output neural network to generate a prediction that characterizes the entity after the time window.
